(19) United States
(12) Patent Application Publication
(10) Pub. No.: US 2009/0028476 A1
(43) Pub. Date: Jan. 29, 2009

(54) ANTI-LEAKAGE DEVICE IN A FAN FOR AN OILY BEARING

(76) Inventors: Chi Ai, Kaohsiung (TW); Hung-Guang Li, Kaohsiung (TW)

Correspondence Address: G. LINK CO., LTD., 3550 BELL ROAD, MINOOKA, IL, 60447, US

(21) Appl. No.: 11/781,958

(22) Filed: Jul. 24, 2007

(51) Int. Cl. F16C 32/06

(52) U.S. Cl. 384/114

(57) ABSTRACT

A fan with an anti-leakage device for an oily bearing includes a base, an axial barrel, a fan wheel and a bearing. The axial barrel extends from the base and provides a first end, a second end, a first oil storage groove at the second end. The fan wheel extends a spindle from the inner side thereof and provides a joining part surrounding an end of the spindle to be adjacent to the inner side of the first end. The bearing is received in the axial barrel and further includes an axial bore, which provides two cone shaped ends, and at least a second oil storage groove, which is provided at a wall surface thereof for being adjacent to the spindle closely; and a reduced-curve end, which is opposite to the joining part. Thus, a closed circuit is formed for the lubrication oil flowing back to the bearing without leakage.

### BACKGROUND OF THE INVENTION

1. Field of the Invention

The present invention is related to a fan with anti-leakage device for an oily bearing and particularly to an anti-leakage device capable of avoiding waste of lubrication oil and lasting life span of the fan.

2. Brief Description of the Related Art

The conventional fan shown in FIG. 1 has a main body 10 with a locating seat 11 at the center of the main body 10. An axial barrel 111 extends upward the locating seat 11 and receives a bearing 12. A coil 13 is provided to surround the axial barrel 111. A fan wheel 14 provides a plurality of blades 141 extending outward radially and a magnetic ring 142 surrounding the inner side thereof to correspond to coil 13. A spindle 143 extends from the inner side of the fan wheel 14 to insert into the bearing 12 and held by a retaining ring 15 and an oil ring 16.

The preceding conventional fan has a problem while in use. The bearing 12 is capable of releasing lubrication oil via the sintered hole to lubricate the spindle 143 during high speed rotation for avoiding dry friction. However, the oil ring 16 is incapable of stopping the lubrication oil to move outward from clearances of the outer end of the axial barrel 111 along with centrifugal force of the spindle 143. As a result, lubrication oil leaks outward via a gap between the axial barrel 111 and the spindle 143 and it occurs excessive wear of the bearing 12. Due to depletion of the lubrication oil, friction between the spindle 143 and the bearing 12 is caused such that noise is created and life span of the fan is shortened.

### SUMMARY OF THE INVENTION

In order to overcome the preceding deficiencies of the conventional fan, an object of the present invention is to provide an anti-leakage device in a fan for an oily bearing in which a second oil storage groove is provided at the wall surface of the axial through bore of the bearing such that the lubrication oil between the bearing and the spindle is incapable of moving outward along the outer surface of the spindle under influence of capillary action and centrifugal force of the spindle.

Another object of the present invention is to provide an anti-leakage device in a fan for an oily bearing in which two ends of the axial through bore of the bearing are inverted cone shaped ends to constitute a line contact between the bearing and the spindle and avoid point wear.

A further object of the present invention is to provide an anti-leakage device in a fan for an oily bearing in which the bearing provides a reduced-curve end to correspond to a joining part at the inner side of the fan wheel such that lubrication oil, which is blocked by the joining part, can return to the bearing along the reduced-curve end.

In order to achieve the preceding objects, a fan according to the present invention includes a base, an axial barrel, a fan wheel and a bearing. The axial barrel extends from the base and provides a first end, a second end and a first oil storage groove disposed at the second end. The fan wheel extends out a spindle from the inner side thereof and provides a joining part to surround an end of the spindle and to be adjacent to the inner side of the first end of the axial barrel. The bearing is received in the axial barrel and further includes an axial through bore, which provides two inverted cone shaped ends, and at least a second oil storage groove, which is provided at a wall surface thereof for being adjacent to the spindle closely; and a reduced-curve end, which is opposite to the joining part. Thus, a closed circuit is formed for the lubrication oil flowing back to the bearing without leakage.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a sectional view of the conventional fan;

FIG. 2 is a perspective view of a preferred embodiment of an anti-leakage device in a fan for an oily bearing according to the present invention;

FIG. 3 is an exploded sectional view of the preferred embodiment of an anti-leakage device in a fan for an oily bearing according to the present invention;

FIG. 4 is an assembled sectional view of the preferred embodiment of an anti-leakage device in a fan for an oily bearing according to the present invention;

FIG. 4A is an enlarged view of the portion enclosed by the dash circle 4A shown in FIG. 4;

FIG. 4B is an enlarged view of the portion enclosed by the dash circle 4A shown in FIG. 4;

FIG. 5 is a cross section of the second oil storage part illustrated in the preferred embodiment; and

FIG. 6 is a cross section of the second oil storage part similar to FIG. 5 illustrating another state thereof.

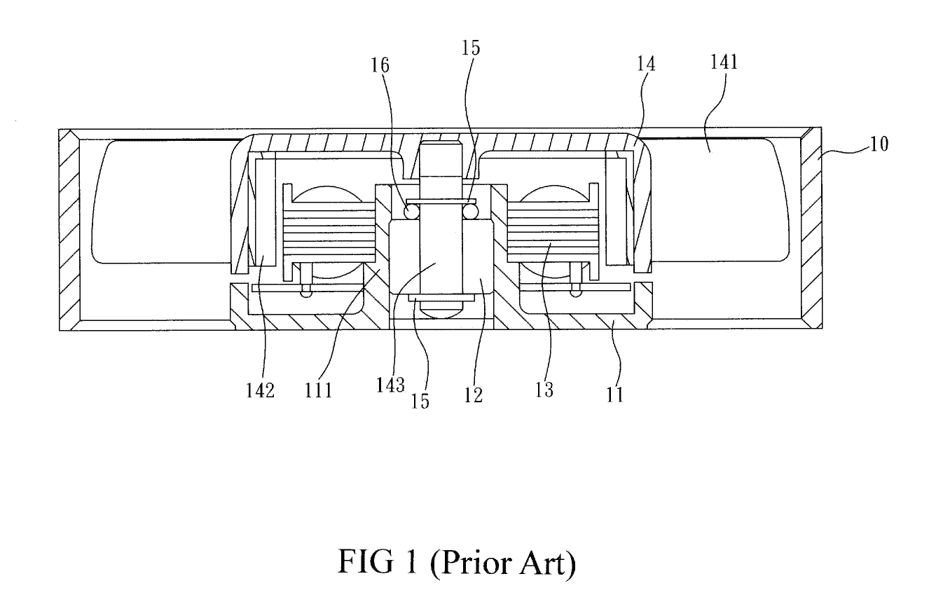

### DETAILED DESCRIPTION OF THE INVENTION

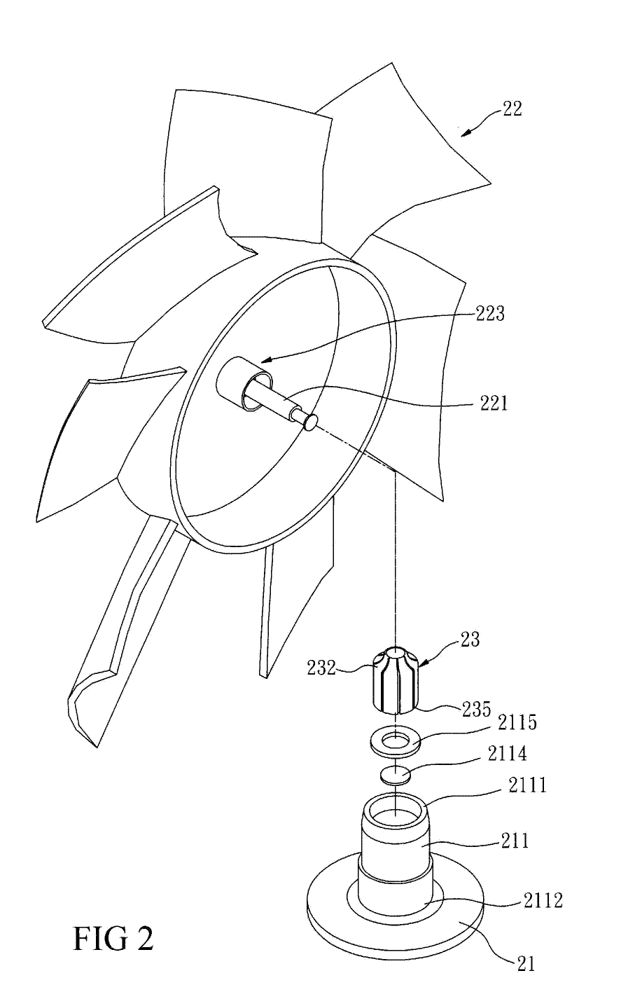

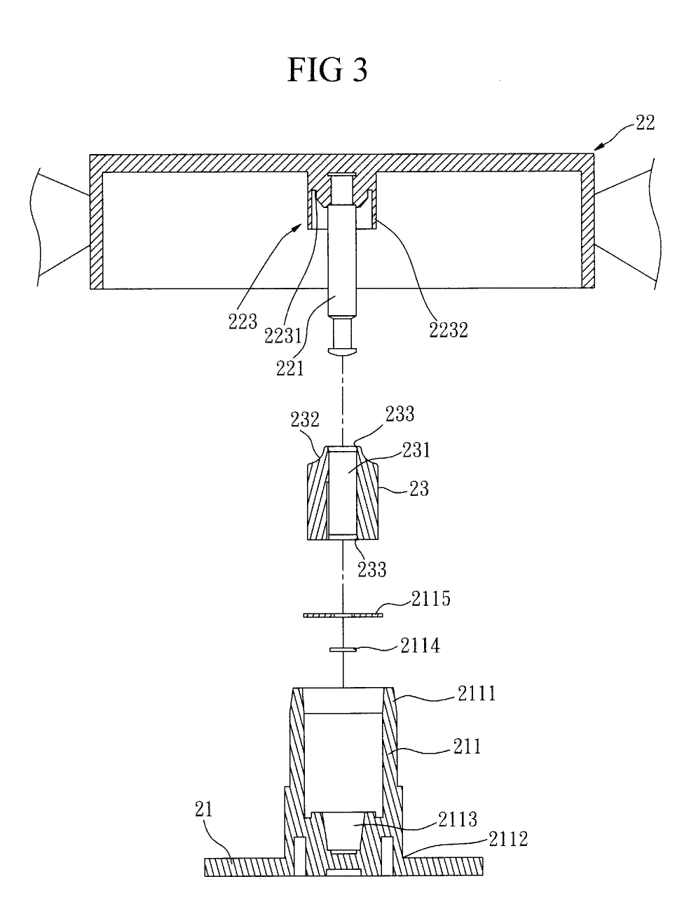

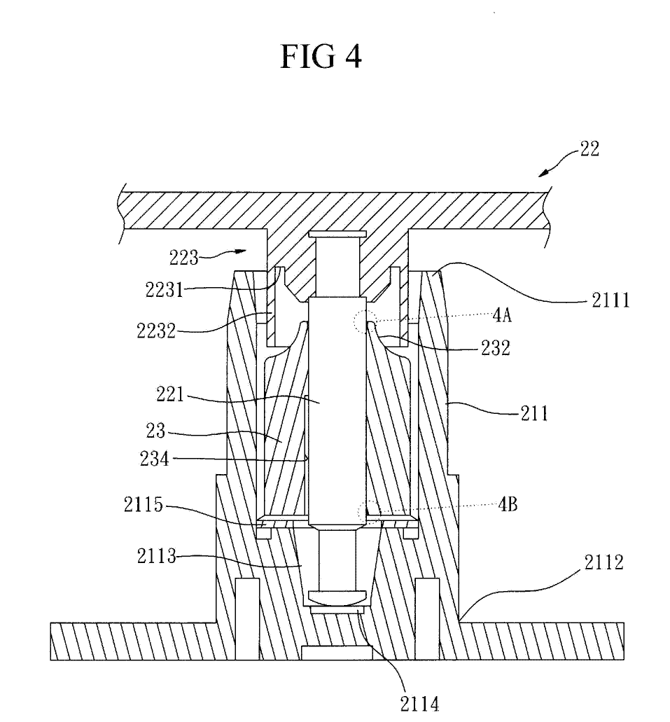

Referring to FIGS. 2 to 4, 4A, 4B and 5 to 6, a fan with an anti-leakage device according to the present invention includes a base 21, a fan wheel 22 and a bearing 23. The base 21, which can be disposed in a fan frame or attached to a heat sink, provides an axial barrel 211 for receiving the bearing 23. The fan wheel 22 has a spindle 221 fitting with the bearing 23 such that the fan wheel 22 is capable of rotating on the base 21.

The axial barrel has a first end 2111 and a second end 2112. A first oil storage groove 2113 is disposed at the inner side of the second end 2112. A wearable piece 2114 is disposed at the bottom of the first oil storage chamber 2113 and a retaining ring 2115 is disposed at the top of the first oil storage groove 2113. The second end 2112 shown in the figures is a closed end but it can be arranged as an open end or an open end with a lower cover (not shown).

The spindle 221 extends outward from the center of the inner side of the fan wheel 22. A joining member 223 is formed at the center of the inner side enclosing the root of the spindle 221 to correspond to the first end 2111 of the axial barrel 211. The joining member 223 further includes an inner annular recess 2231, which surrounds the root of the spindle 221, and an outer cylinder 2232, which is joined to the inner annular recess 2231. The outer cylinder 2232 is adjacent to the inner side of the first end 2111.

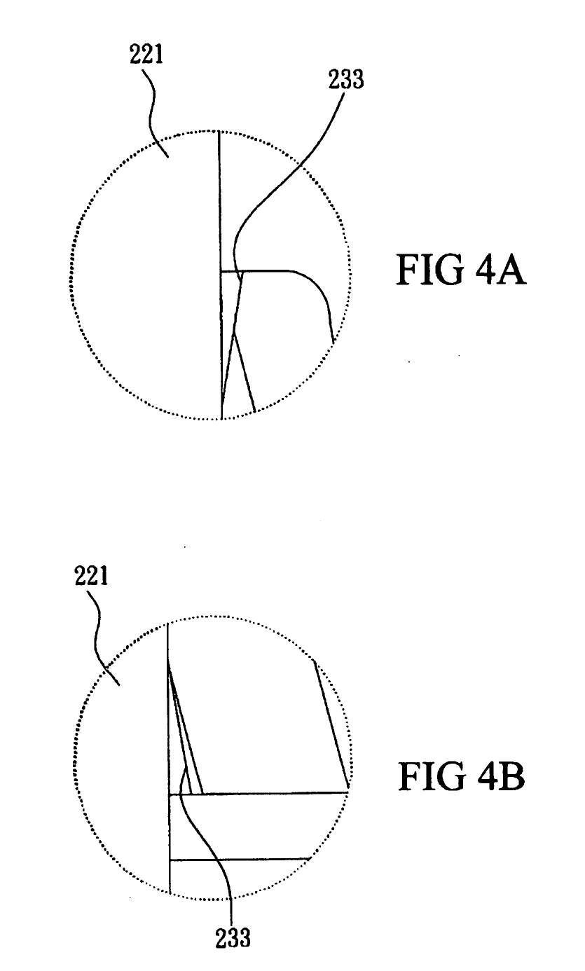

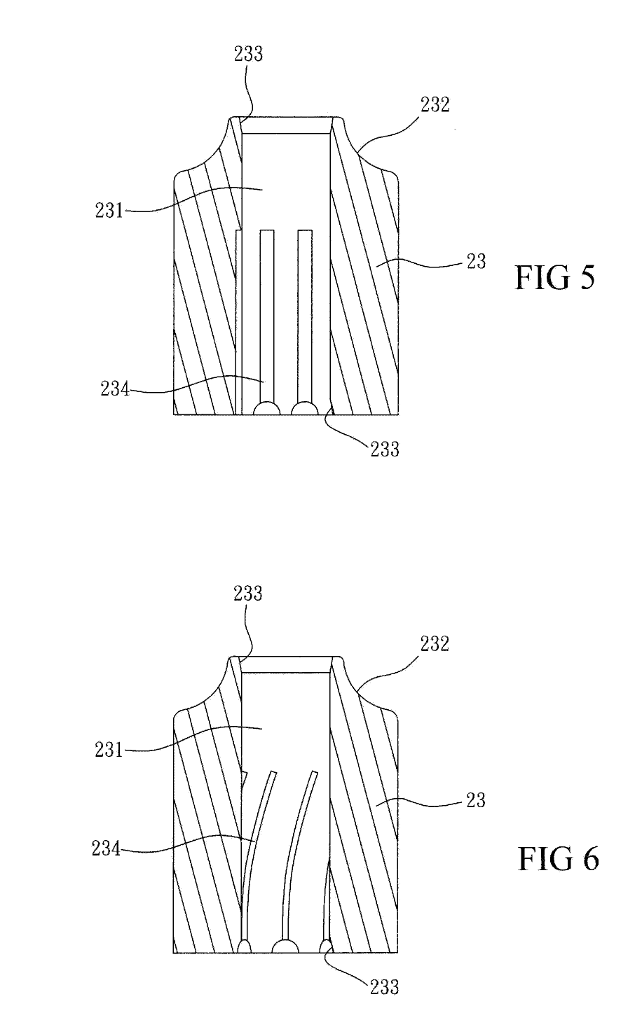

The bearing 23, which is received in the axial barrel 211, has a reduced end 232 except having an axial through bore 231. The axial through bore 231 has two inverted cone shaped ends 233 and the wall surface of the axial through bore 231 at least has a second oil storage groove 234. The reduced end 232 is provided to correspond to the joining member 223. The outer surface of the bearing 23 provides at least an elongated furrow 235 extending downward to the plain end thereof from the reduced end 232. The second oil storage groove 234 is elongated and axially extends from the middle section of the wall surface of the axial bore 231 to an end, which is next to the plain end of the bearing 23, as shown in FIG. 5. Alternatively, the second oil storage groove 234 extends from the middle section of the wall surface of the axial bore 231 spirally as shown in FIG. 6.

The spindle 221 is inserted into the axial bore 231 with the free end thereof plunging into the first oil storage groove 2113 and the retaining ring 2115 at the top of the first oil storage groove 2113 holds the spindle 221. Meanwhile, the free end contacts with wearable piece 2114 and the outer surface of the spindle 221 is adjacent to the second oil storage groove 234.

Thus, when the spindle 221 rotates with respect to the bearing 23, the lubrication oil in the first oil storage groove 2113 moves outward along the spindle 221 to allow most of the lubrication oil staying in the second oil storage groove 234 to prevent dry friction between the spindle 221 and the wall surface of the axial bore 231. Meanwhile, only a small amount of the lubricant, which keeps moving along the outer surface of the spindle 221, fall to the inverted cone shaped end 233, which is neighboring to the joining part 223, and the outer surface of the reduced end 232 after being stopped by the outer cylinder 2232 and the annular recess part 2231 and flows back to the first oil storage groove 2113 along the elongated furrow 235. Therefore, the anti-leakage device recited above provides double protection for the lubricant from leaking outward.

Additionally, the lubrication oil received by the inverted cone shaped end 233 becomes a protection zone of lubrication oil between the inverted cone shaped end 233 and the outer surface of the spindle 221 to prevent phenomenon of point wear at the bearing 23 due to deviation of the spindle 221.

While the invention has been described with referencing to a preferred embodiment thereof it is to be understood that modifications or variations may be easily made without departing from the spirit of this invention, which is defined by the appended claims.

What is claimed is:

1. A fan with an anti-leakage device for an oily bearing comprising:
a base;
an axial barrel extending from the base, providing a first end and a second end and providing a first oil storage groove therein at the second end;
a fan wheel extending a spindle from the inner side thereof and providing a joining part surrounding an end of said spindle to be adjacent to the inner side of said first end; and
a bearing being received in the axial barrel and further comprising:
an axial bore providing two cone shaped ends and providing at least a second oil storage groove at a wall surface thereof for being adjacent to the spindle closely; and
a reduced-curve end being opposite to said joining part.

2. The fan with an anti-leakage device for an oily bearing as defined in claim 1, wherein the outer surface of said bearing provides at least a elongated furrow extending from said reduced-curve end to the other end of said bearing.

3. The fan with an anti-leakage device for an oily bearing as defined in claim 1, wherein the joining member further includes an inner annular recess, which surrounds the root of the spindle, and an outer cylinder, which is joined to the inner annular recess and being adjacent to the inner side of the first end.

4. The fan with an anti-leakage device for an oily bearing as defined in claim 1, wherein said second oil storage groove extend from the middle section of the wall surface of the axial bore to an end thereof away from said reduced-curve end.

5. The fan with an anti-leakage device for an oily bearing as defined in claim 1, wherein said second oil storage groove extends axially.

6. The fan with an anti-leakage device for an oily bearing as defined in claim 1, wherein said second oil storage groove extends helically.
